(19) United States
(12) Patent Application Publication
(10) Pub. No.: US 2022/0299671 A1
(43) Pub. Date: Sep. 22, 2022

(54) CONCEALED MINERAL RESOURCE PREDICTION METHOD AND LOGGING SYSTEM BASED ON PETRO-ELECTROMAGNETISM

(71) Applicant: Institute of Geology and Geophysics, Chinese Academy of Sciences, Beijing (CN)

(72) Inventor: Lanfang HE, Beijing (CN)

(21) Appl. No.: 17/716,426

(22) Filed: Apr. 8, 2022

Related U.S. Application Data
(63) Continuation of application No. PCT/CN2020/118634, filed on Sep. 29, 2020.

(30) Foreign Application Priority Data
Oct. 18, 2019 (CN) 201910993947.X

(51) Int. Cl. G01V 3/30

(52) U.S. Cl. CPC G01V 3/30

(57) ABSTRACT

Disclosed is a concealed mineral resource prediction method and a petroEM logging system, which are applied to the technical field of mineral and oil/gas resource exploration. The petroEM logging system provided by the present application adopts a broadband (0.001-10000 Hz) sweep frequency mode, can perform broadband complex impedance measurement of the rock, and can realize potential mineral or oil/gas resource prediction through the obtained PetroEM prediction factor separately or in combination with geochemical characteristics.

### TECHNICAL FIELD

The present application belongs to the technical field of mineral resource exploration, and relates to mineral (oil/gas) logging and exploration, in particular to a concealed mineral resource prediction method for strata and deposit property recognition, and a petro-electromagnetism (PetroEM) logging system used in the resource prediction.

### BACKGROUND

Drilling (borehole) is one of the most direct means to obtain the strata information, and it is also the most important exploration means to verify and discover concealed mineral (including oil and gas) resources. Logging (also names as geophysical logging) is a method to measure geophysical parameters by using the geophysical property of rock mass or strata, such as electrochemical property, electrical conductivity, acoustic property and radioactivity. Conventional logging methods include resistivity logging, electromagnetic induction logging and dielectric logging.

Resistivity logging is to transmit and receive a DC electric field in a well through a specific device to obtain the electrical parameters of the stratum. The common output parameter is stratum resistivity, which is easy to be affected by drilling fluid and well tools. Besides, this method transmits the high frequency or small power supply distance, and, result in shallow maximum penetration depth. Electromagnetic induction logging employs the alternating electric field in the stratum and measure the conductivity of the stratum. The induced logging array, based the principle similar to that of ordinary electromagnetic induction logging, and performs the measurement using sensors system with more coils. Electromagnetic Propagation Logging (EPT), also known as UHF (ultra-high frequencies) dielectric logging, is a logging method to distinguish oil and water layers and determine the water content in the strata by measuring the parameters closely related to the dielectric constant of the strata (electromagnetic wave propagation time and electromagnetic wave attenuation rate). Electromagnetic induction logging and dielectric logging receive a secondary field generated by electromagnetic induction. They work in high use frequency (25000 Hz-1 G Hz) ranges, and features with small the maximum penetration depth of ten to tens of centimeters.

### SUMMARY

The purpose of the present is to provide a mineral resource prediction method aiming at improving the prediction performance electrical logging. It aims to overcome the weaknesses of conventional methods leads by single output parameter, narrow frequency range, poor recognition ability of complex environment and small penetration depth. This present performs complex impedance measurement and analysis to a deposit by using broadband transmitted electromagnetic waves (especially including low-frequency transmitted electromagnetic waves), so as to improve the predicting accuracy in the mineral system.

In order to achieve the purpose, the present application adopts the following technical solution.

A concealed resource prediction method provided by the present application includes the following steps:

A1) complex impedance measurement:

performing complex impedance (CR) measurement to an ore deposit or oil/gas reservoir and their hosted rock samples obtained from a borehole or tunnel in an exploration area within a set frequency range;

or performing borehole CR measurement along the borehole or tunnel in the exploration area within the setting frequency range;

A2) prediction factor extraction: based on the complex impedance measurement result, extracting the resistivity and phase information of the ore body or oil/gas reservoir and the hosted rock samples at different frequencies band in the exploration area, then obtaining impedance phase differences or resistivity ratios of the ore body or oil/gas reservoir and the hosted rock samples at multiple set frequencies in the same frequency band, and using an average value of the obtained multiple impedance phase differences or resistivity ratios as an electromagnetic prediction factor;

A3) mineral resource prediction: predicting concealed mineral resources in the exploration area using the obtained electromagnetic prediction factor and a setting standard.

In the PetroEM logging system, the exploration area is an area where ore-bearing, water-bearing or oil/gas resources need to be predicted.

In the concealed resource prediction method, the purpose of step A1 is to realize the complex impedance measurement of the borehole or tunnel in the exploration area at different frequency set. It can realize the complex impedance measurement of the ore body or oil/gas reservoir and the hosted rock samples obtained from the borehole or tunnel in the exploration area, or the borehole complex impedance logging along the borehole or tunnel. The setting frequency range is 0.001-10000 Hz. In a preferred embodiment, the set frequency range is 0.001-0.01 Hz. Within this frequency range, the influence of capacitance effect and electromagnetic coupling effect can be greatly reduced. Therefore, the measurement result better reflects the attribute of the explored target. Meanwhile, electromagnetic waves in this frequency range have a greater penetration depth than medium-frequency and high-frequency (higher than 0.01 Hz) electromagnetic waves, such that a wider range of information around the borehole can be explored.

When the complex impedance measurement is performed to the samples, the adopted PetroEM measurement system includes containers containing a medium solution disposed at two ends of the core sample and an impedance analyzer. A contact position between the core sample and each container is provided with conductive adhesive, and a current electrode and a reference electrode connected with the impedance analyzer are inserted into the medium solution. The complex impedance is measured by the impedance analyzer in the frequency ranges from 0.001-10000 Hz. In a preferred embodiment, the frequency ranges from 0.001-0.01 Hz. The medium solution is copper sulfate or silver chloride solution, and the corresponding electrode is copper or silver. The reference (voltage) electrode is non-polarized, such as a silver-silver chloride electrode, which is a disclosed electrode. The PetroEM measurement system provided by the present application can overcome the influence of low-frequency polarization reaction by isolating the dielectric solution (or colloid) and the core sample through the conductive adhesive disposed between them, so as to measure the complex impedance of the core sample at low frequency, thus realizing the effective expansion of the complex impedance measurement from a medium band (0.01-100 Hz) to a wide band (0.001-10000 Hz), especially low frequency range.

When the relevant complex impedance measurement result is obtained by performing borehole complex impedance logging at different set frequencies along the borehole or tunnel, the adopted petroEM logging system is somewhat similar to a DC resistivity logging device, which can be implemented in the following two modes:

(1) The petroEM logging system includes a ground-based transmitter system and data acquisition unit (DAU) and an electrode placed in borehole. The electrode includes transmitter electrode and receiver electrode. The electrodes are connected to the transmitter of DAU through transmission cable. The receiver electrodes are connected receiver DAU through receiver cable. The transmitter transmits electromagnetic waves within a frequency range of 0.001-10000 Hz into the logging borehole through the transmitting electrodes. The DAU measures complex impedance in the borehole through the receiver electrodes. In a preferred embodiment, the transmit frequency ranges from 0.001 to 0.01 Hz.

(2) The petroEM logging system includes a ground based transmitter system, DAU and electrode placed in borehole. The electrode includes electrodes and voltage (measurement) electrodes. The electrodes are connected to the transmitter through transmission cable. The receiver electrodes are connected to the borehole DAU. The transmitter transmits electromagnetic waves within a frequency range of 0.001-10000 Hz into the logging borehole through the transmitting electrodes. The DAU measures complex impedance in the borehole through the receiver electrodes. In a preferred embodiment, the transmit frequency ranges from 0.001 to 0.01 Hz.

The transmitter in the first implementation or the second implementation may be a signal generator or other devices with an electromagnetic wave transmitting function, which can transmit broadband electromagnetic wave signals of different frequencies setting to ground and record the transmitting current. The DAU in the first implementation or receiver device in the second implementation may be a geo-electromagnetic data acquisition device, which can measure and record the AC voltage from the receiver electrodes on the near surface or in the borehole. Using the recorded transmitting current and AC voltage, the complex impedance is calculated by Ohm's Law.

In the concealed resource mineral prediction method, the purpose of step A2 is to extract the electromagnetic prediction factor based on the complex impedance measurement result, mainly to extract the resistivity and phase information of a target deposit in the exploration area at different frequencies setting, then calculate the phase differences or resistivity (or Impedance modulus) ratios of the exploration area at multiple frequency in the same frequency band (e.g., low frequency band (0.001-0.01 Hz), medium frequency band (0.01-100 Hz) or high frequency band (100-10000 Hz)) according to phase information of a target deposit, and use the obtained impedance phase differences or resistivity ratios of the exploration area in the same frequency band as the electromagnetic prediction factor. In order to facilitate the comparison with the set standard, an average value of the multiple impedance phase differences or resistivity ratios may also be taken as the electromagnetic prediction factor. A real part and an imaginary part of the measured complex impedance are calculated through Fourier transform (the corresponding impedance amplitude and phase can be obtained through the real part and the imaginary part). On this basis, the resistivity can be calculated by multiplying the impedance amplitude by a shape coefficient of the sample or a device coefficient of the target ore body/oil/gas reservoir/bed rock target deposit (for the calculation of the device coefficient, refer to Wang Lanwei, Zhang Shizhong, Zhang Yu, Hu Zhe, Yan Rui. 2014 Calculation of the Configuration Coefficient in the Deep-well Geo-electrical Resistivity Observation—Taking Deep-well Observation of Tianshui Earthquake Station as an Example. Chinese Journal of Engineering Geophysics, 11: 50-59). The resistivity and phases at different frequencies set are used as the electromagnetic prediction factor. Because different types of ore bodies and bed rocks have different frequency dispersion response, the impedance phase difference or resistivity ratio of the ore body or oil/gas reservoir and the bed rock in the exploration area in the same frequency band can reflect the ore bearing or oil/gas reservoir situation of resources, so as to predict the minerality of exploration targets.

The purpose of step A3 is to predict the mineral resources in the exploration area according to the electromagnetic prediction factor. Relevant standards may be set according to empirical measurement data. Then the electromagnetic prediction factor are compared with the setting standard to predict the ore-bearing (or oil/gas) situation.

The present application provides another concealed resource mineral prediction method, which includes the following steps:

B1) complex impedance measurement:

performing complex impedance measurement to an ore body or oil/gas reservoir and a bed rock sample obtained from a borehole or tunnel in an exploration area within a set frequency range;

or performing in-well complex impedance measurement along the borehole or tunnel in the exploration area within the set frequency range;

B2) prediction factor extraction and model establishment: according to a complex impedance measurement result, extracting resistivity and phase information at different frequency setting, and using the resistivity and phases as electromagnetic prediction factor; then, according to a correlation between electromagnetic characteristics and geochemical characteristics obtained through rock geochemical analysis, obtaining geochemical prediction factor at different set frequencies, and further, according to the obtained electromagnetic prediction factor and geochemical prediction factor at different set frequencies, establishing a resistivity-phase-rock attribute model;

B3) resource prediction: predicting the concealed resources in the exploration area by using the established PetroEM model.

In the concealed resource prediction method, the purpose of step B1 is to realize the complex impedance measurement of the exploration area at different set frequencies. It can realize the complex impedance measurement of the ore body or oil/gas reservoir sample obtained along the depth direction (i.e., the target deposit) of the exploration area, or the in-well complex impedance logging along the borehole or tunnel. It is the same as the measurement method of the complex impedance in the exploration area in the first resource prediction method given above, and will not be further described here.

In the concealed resource prediction method, the purpose of step B2 is to extract the electromagnetic prediction factor and geochemical prediction factor according to the complex impedance measurement result, and then establish the resistivity-phase-rock attribute model. A real part and an imaginary part of the measured complex impedance are calculated through Fourier transform (the corresponding impedance amplitude and phase can be obtained through the real part and the imaginary part). On this basis, the resistivity can be calculated by multiplying the impedance amplitude by a shape coefficient of the sample or a device coefficient of the target ore body/oil/gas reservoir/bed rock target deposit (for the calculation of the device coefficient, refer to Wang Lanwei, Zhang Shizhong, Zhang Yu, Hu Zhe, Yan Rui, 2014: Calculation of the Configuration Coefficient in the Deep-well Geo-electrical Resistivity Observation—Taking Deep-well Observation of Tianshui Earthquake Station as an Example. Chinese Journal of Engineering Geophysics, 11: 50-59). The resistivity and phases at different set frequencies are used as the electromagnetic prediction factor.

Through preliminary research, the correlation between the electromagnetic prediction factor obtained through the complex impedance measurement and the geochemical prediction factor obtained through rock geochemical analysis is established. In the later stage, the electromagnetic prediction factor are obtained through the complex impedance measurement of the rock, and then the rock geochemical prediction factor in the exploration area can be obtained quickly according to the established correlation between them. Then, according to the comprehensive analysis of the electromagnetic prediction factor and the geochemical prediction factor related to the rock, the resistivity-phase-chemical attribute model related to the rock is established. In the preliminary research, through the complex impedance analysis of the rock in the area for several proved typical metal ore deposits or oil/gas reservoirs, the electromagnetic prediction factor such as resistivity and phase related to the rock are obtained. The geochemical prediction factor related to resources (such as metal sulfide content, macro metal content, quartz content and other geochemical prediction factor related to metal ore, or Total Organic Carbon (TOC) content, quartz content, loss on ignition, pyrite content and other geochemical prediction factor related to oil/gas) are obtained by conventional means (macro-analysis, micro-analysis, loss-on-ignition analysis, etc.). Then, the correlation between the electromagnetic prediction factor and the geochemical prediction factor is established through correlation coefficient analysis and scatter point analysis, which may be presented by graphic, mathematical or physical expression. Later, after the electromagnetic prediction factor related to the rock in the exploration area are obtained, the geochemical prediction factor in the exploration area can be obtained by comparison or inferring. Comparison refers to that, by comparing the information related to the ore-bearing (oil/gas) target (electromagnetism and petrology) with the electromagnetic characteristics of different characteristic types of deposits or reservoirs, the landmark geochemical prediction factor that can characterize the exploration area can be obtained, a corresponding resistivity-phase-rock attribute model can be established, and the ore bearing property of the exploration area can be obtained through comparison. Inferring refers to that a PetroEM model is established by using the ore-bearing target, the geochemical prediction factor of the ore body or oil/gas reservoir are inferred according to the measured electromagnetic prediction factor, a corresponding resistivity-phase-rock attribute model is established, and then the established model is used to predict and analyze the potential ore bearing property of the exploration area.

Obviously, those skilled in the art can further evaluate the resource potential of the exploration area through the established resistivity-phase-rock attribute model on the basis of predicting whether the exploration area contains ore according to the impedance phase differences or resistivity ratios in different frequency bands, so as to further predict the ore-bearing (or oil/gas) situation of the exploration area, thus improving the success rate of resource prediction.

Compared with the prior art, the present application has the following advantages or progress:

1. The present application adopts a broadband (0.001-10000 Hz) sweep frequency mode, can realize broadband complex impedance measurement of the rock, and can realize potential mineral or oil/gas resource prediction through the obtained PetroEM prediction factor separately or in combination with geochemical characteristics.

2. The present application obtains the impedance phase differences or resistivity ratios between the ore body or oil/gas reservoir and the bed rock in the exploration area at multiple set frequencies through the difference method based on different frequency dispersion responses of different rocks and ores in the frequency band range, and uses the calculated phase differences or resistivity ratios to predict the ore-bearing or oil/gas resources of the target deposit in the exploration area.

3. The present application establishes the relationship between electromagnetic characteristics and the geochemical characteristics of mineral or oil/gas target deposit through PetroEM analysis, and uses electromagnetic and geochemical analysis to predict the ore-bearing or oil/gas resources of the target deposit in the exploration area. Since the electromagnetic and geochemical properties of the rock layer are considered at the same time, the prediction success rate can be further improved.

4. The present application can realize the complex impedance measurement of the rock in the exploration area under the excitation of electromagnetic waves at very low frequencies (0.001-0.01 Hz), and thus can greatly improve the penetration depth in rock logging (one meter to more than ten meters), so that the concealed target in a wider range around the borehole or tunnel can be predicted.

### BRIEF DESCRIPTION OF THE DRAWINGS

FIG. 1 illustrates a schematic diagram of a PetroEM measurement system based on core complex impedance measurement provided by the present, in which 1—PetroEM measurement system, 11—core sample, 12—impedance analyzer, 13—copper sulfate colloid, 14—copper plate, 15—reference electrode, 16—conductive adhesive.

FIG. 2 illustrates a schematic diagram of a PetroEM measurement system based on logging technology provided by the present application, in which 2—petroEM logging system, 21—transmitting-receiver device, 22—electrode device.

FIG. 3 illustrates a schematic diagram of another PetroEM measurement system based on logging technology provided by the present application, in which 3—petroEM logging system b, 31—transmitting device, 32—receiver device, 33—electrode device.

FIG. 4 illustrates PetroEM characteristics of an ore body and bed rock obtained in Application Example 1.

FIG. 5 illustrates PetroEM characteristics of organic-rich shale and bed rock (argillaceous sandstone) obtained in Application Example 2.

FIG. 6 illustrates a schematic diagram of analysis results of a correlation between resistivity characteristics and geochemical characteristics given in Application Example 3, in which (a) is a schematic diagram of analysis results of a correlation between resistivity characteristics and TOC, (b) is a schematic diagram of analysis results of a correlation between calcium oxide content and loss on ignition.

FIG. 7 illustrates a schematic diagram of analysis results of a correlation between resistivity characteristics and geochemical characteristics (quartz content) given in Application Example 3.

FIG. 8 illustrates resistivity-phase-geochemical attribute models established by extracting geochemical prediction factor through comparison in Application Example 3, in which (a) to (d) are measurement results of a known well X, (e) to (h) are measurement results of a prediction well Y, (a) and (e) are depth-resistivity curves, (b) and (f) are depth-TOC curves, (c) and (g) are depth-impedance phase curves, (d) to (h) are depth-quartz content curves.

FIG. 9 illustrates a resistivity-phase-geochemical attribute model established by extracting geochemical prediction factor through inferring and actually measured results in Application Example 3, in which (a) to (b) are electromagnetic measurement results of a prediction well (XD well), (c) is the TOC content of the XD well obtained by inferring, and (d) is gas desorption amount actually measured in the prediction well (XD well).

### DETAILED DESCRIPTION

The present application will be described in detail through the embodiments below. It is necessary to point out here that the embodiments are only used to further describe the present application, but cannot be understood as limiting the scope of protection of the present application. Those skilled in the art can make some non-essential improvements and adjustments to the present application according to the content of the present application.

### Embodiment 1

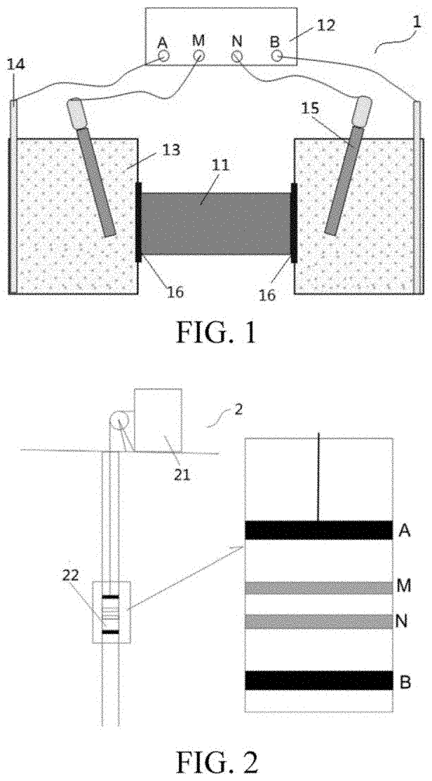

Referring to FIG. 1, a PetroEM measurement system 1 based on core complex impedance measurement provided by this embodiment includes two containers containing copper sulfate colloid 13 and an impedance analyzer 12. A core sample 11 is placed between the two containers. Copper sulfate colloid is obtained by mixing about 1 L of saturated copper sulfate solution and about 5 kg of flour (which may also be replaced with clay). A through hole is provided at the contact position between an outer wall of each container and the core sample 11. Conductive adhesive 16 is provided between the core sample and a position of contact with the copper sulfate colloid. Transmitting ends A and B of the impedance analyzer 12 are respectively connected with copper plates 14 inserted into the copper sulfate colloid 13 through conducting wires. receiver ends M and N of the impedance analyzer are respectively connected with reference electrodes 15 inserted into the copper sulfate colloid 13 through conducting wires. Copper plate-copper sulfate constitutes metal-metal salt. The reference electrode is an electrode used for reference comparison when measuring various electrode potentials. In this embodiment, a silver-silver chloride electrode is adopted. A frequency range applied by the impedance analyzer is 0.001-10000 Hz.

The working principle of the rock electromagnetism measurement system 1 is as follow: by accurately measuring the AC voltage of different set frequencies loaded to the two ends of the sample and the current passing through the sample, the resistivities and impedance phases at different set frequencies are obtained according to the calculation method given above. The conductive adhesive provided between the copper sulfate colloid and the core sample can isolate them, thus overcoming the influence of low-frequency polarization reaction, realizing the complex impedance measurement of the core sample at low frequency, and effectively expanding the complex impedance measurement in a wide frequency band The traditional measurement method is difficult to overcome the influence of low-frequency polarization reaction, and the low-frequency range is generally more than 0.01 Hz.

### Embodiment 2

Referring to FIG. 2, a petroEM logging system a2 based on logging technology provided by this embodiment includes a transmitting-receiver device 21 placed on the ground and an electrode device 22 placed in a logging well. The electrode device includes transmitting electrodes (A, B) and receiver electrodes (M, N). The transmitting electrodes (A, B) are connected with a transmitting end of the transmitting-receiver device through transmission lines. The receiver electrodes (M, N) are connected with a receiver end of the signal transmitting-receiver device through transmission lines. The transmitting part of the transmitting-receiver device is used to transmit electromagnetic waves within a frequency range of 0.001-10000 Hz, and may be a signal generator or other devices with an electromagnetic wave transmitting function, which can transmit broadband electromagnetic wave signals of different set frequencies underground and record the transmitting current. The receiver part of the transmitting-receiver device adopts a magnetotelluric signal acquisition device (refer to the magnetotelluric signal acquisition device disclosed in application document CN200910081483.1) to measure and record the AC voltage through the receiver electrodes. Then, the resistivity and impedance phase are calculated according to the calculation method given above.

### Embodiment 3

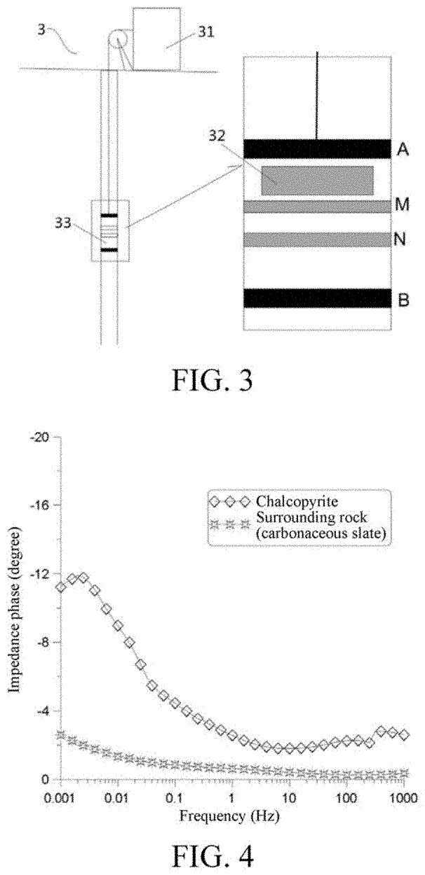

Referring to FIG. 3, a petroEM logging system b3 based on logging technology provided by this embodiment includes a transmitting device 31 placed on the ground, and a receiver device 32 and an electrode device 33 placed in a logging well. The receiver device and the electrode device can be nested and mounted together. The transmitting device is used to transmit electromagnetic waves within a frequency range of 0.001-10000 Hz, and may be a signal generator or other devices with an electromagnetic wave transmitting function, which can transmit broadband electromagnetic wave signals of different set frequencies underground and record the transmitting current. The receiver device may adopt a downhole electromagnetic receiver or seabed electromagnetic receiver (the principle is the same as that of a ground electromagnetic receiver, but the volume can be as small as 15 cm*5 cm*5 cm or even smaller) to measure and record the AC voltage through the receiver electrodes. The electrode device includes transmitting electrodes (A, B) and receiver electrodes (M, N). The transmitting electrodes are connected with a transmitting end of the transmitting device through transmission lines. The receiver electrodes are connected with a receiver end of the receiver device through transmission lines. The transmitting device transmits electromagnetic waves into the logging well through the transmitting electrodes and records the transmitting current. The receiver device measures and records the AC voltage through the receiver electrodes. Then, the resistivity and impedance phase are calculated according to the calculation method given above.

### Application Example 1

Different rocks and ores have different dispersion responses in a wide frequency band. Ores and non-ores can be distinguished by using multiple frequency impedance phase differences (or ratios) of frequency dispersion response. The level of difference can qualitatively reflect the metal (or bed rock) ore bearing characteristics. For example, a low-band phase difference between chalcopyrite with a grade of more than 1% and its bed rock exceeds 5 degrees. When the phase difference is less than or equal to 5 degrees, it is determined that there is no chalcopyrite with a grade of more than 1% in the exploration area; A low-band phase difference between carbonaceous slate and its bed rock is more than 2 degrees. When the phase difference is less than or equal to 2 degrees, it is determined that there is no calcareous slate in the exploration area.

For a certain chalcopyrite exploration area, a concealed resource prediction process includes the following steps:

A1) Complex impedance measurement: within a set frequency range of 0.001-1000 Hz, the PetroEM measurement system 1 provided in embodiment 1 is adopted to perform complex impedance measurement to core samples obtained from an ore body development area and a bed rock area (which here refers to carbonaceous slate) in an exploration area.

A2) prediction factor extraction: for any set frequency, a real part and an imaginary part of the measured complex impedance are calculated through Fourier transform (the corresponding impedance amplitude and phase can be obtained through the real part and the imaginary part); on this basis, the resistivities of the core samples of target deposits in the ore body development area and the bed rock area can be calculated by multiplying the impedance amplitude by the shape coefficient of the sample (the ratio of the contact surface area to the effective length of the sample). The obtained resistivity and impedance phase are two electromagnetic prediction factors.

The change of the impedance phase with the frequency of the core samples of the target deposits in the ore body development area and the bed rock area obtained by the above method is as illustrated in FIG. 4. Within the range of low-band frequency less than 0.01 Hz, the phase information of the target deposits (buried depth of 310 m) of the ore body development area and the bed rock area at five frequencies (0.00126, 0.002, 0.00316, 0.00501, and 0.00794 Hz) is extracted, and then an average value of phase differences between them at five frequencies (i.e., electromagnetic prediction factor, which is 9.05 degrees in this application example) is calculated.

A3) Resource prediction: since the average value of the phase differences between the core samples of the target deposits in the ore body development area and the bed rock area is greater than 5 degrees, it is determined that the ore body development area is a chalcopyrite development area.

Of course, average values of the impedance phases of the core samples of the target deposits in the ore body development area and the bed rock area at five frequencies may also be calculated respectively, and then a difference between the average values of the impedance phases of the core samples of the target deposits in the ore body development area and the bed rock area is calculated and used as an electromagnetic prediction factor.

### Application Example 2

For oil/gas resources, different oil/gas-bearing properties of rocks show different PetroEM characteristics, so the resistivity of a logging well is one of the important indexes of oil/gas analysis. Unconventional oil/gas (such as shale gas) rocks have different frequency dispersion responses in a wide frequency band. Using the multiple frequency impedance phase differences (or ratios) of frequency dispersion response, organic-rich shale (dark shale with TOC of more than 2%, which is the main gas producing layer of shale gas) can be distinguished from other rock strata. For example, a phase difference between shale with TOC content pf more than 2% and bed rock in a low frequency band exceeds 2 degrees. When the phase difference is less than or equal to 2 degrees, it is determined that the exploration area does not contain organic-rich shale (here which refers to marine shale in Upper Yangtze of China).

For a certain organic-rich shale exploration area, a concealed resource prediction process includes the following steps:

A1) Complex impedance measurement: within a set frequency range of 0.001-1000 Hz, the PetroEM measurement system 1 provided in embodiment 1 is adopted to perform complex impedance measurement to core samples obtained from a gas-bearing stratum development area and a bed rock area (which here refers to argillaceous sandstone) in an exploration area.

A2) prediction factor extraction: for any set frequency, a real part and an imaginary part of the measured complex impedance are calculated through Fourier transform (the corresponding impedance amplitude and phase can be obtained through the real part and the imaginary part); on this basis, the resistivities of the core samples of target deposits in the gas-bearing stratum development area and the bed rock area can be calculated by multiplying the impedance amplitude by the shape coefficient of the sample. The obtained resistivity and impedance phase are two electromagnetic prediction factors.

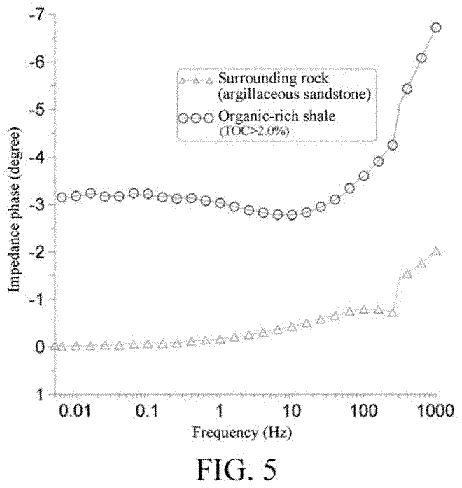

The change of the impedance phase with the frequency of the core samples of the target deposits in the gas-bearing stratum development area and the bed rock area obtained by the above method is as illustrated in FIG. 5. Within the range of low-band frequency less than 0.01 Hz, the phase information of the target deposits of the gas-bearing stratum development area (depth of about 1335 m) and the bed rock area (depth of about 1290 m) at three frequencies (0.005, 0.0063, and 0.0079 Hz) is extracted, and then a difference between average values of phases of them at three frequencies (i.e., electromagnetic prediction factor, which is 3.14 degrees in this application example) is calculated.

A3) Resource prediction: since the average value of the phase differences between the core samples of the target deposits in the gas-bearing stratum development area and the bed rock area is greater than 2 degrees, it is determined that the gas-bearing stratum body development area is an organic-rich shale development area.

### Application Example 3

This application example is the combination of electromagnetic and geochemical analysis to establish a resistivity-phase-rock attribute model to predict oil/gas reservoirs.

By using shale gas reservoir evaluation elements such as clay mineral, brittle mineral, TOC and pyrite and a relationship between the resistivity and the phase of the logging well, the reservoir characteristics of the organic-rich shale can be evaluated through PetroEM research.

A correlation between electromagnetic characteristics and rock geochemical characteristics is established.

Through the electromagnetic analysis and geochemical analysis of a typical oil/gas reservoir (southwest edge of Upper Yangtze plate in South China), a correlation between them is established. Specific steps are as follows:

(i) Core samples at different depths are extracted from the borehole of the oil/gas reservoir. Within a set frequency range (0.001-10000 Hz), the PetroEM measurement system 1 provided in embodiment 1 is adopted to perform complex impedance measurement to the core samples. A real part and an imaginary part of the measured complex impedance are calculated through Fourier transform (the corresponding impedance amplitude and phase can be obtained through the real part and the imaginary part). On this basis, the resistivities of the core samples can be calculated by multiplying the impedance amplitude by the shape coefficient of the sample. The obtained resistivity and impedance phase are two electromagnetic prediction factors.

(ii) Conventional macro-analysis, Total Organic Carbon (TOC) analysis, fluorescence analysis and the like are adopted to obtain geochemical prediction factor related to oil/gas, such as TOC content, quartz content, CaO content and loss on ignition.

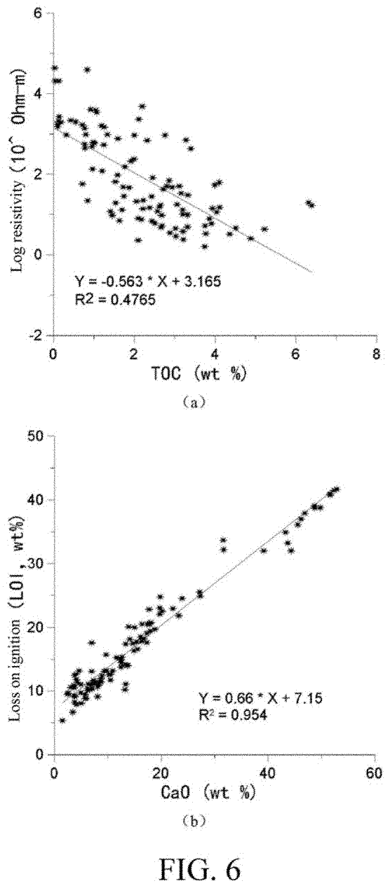

(iii) The test data of log resistivity and TOC measured at 0.01 Hz are summarized, as illustrated in (a) of FIG. 6. A correlation between TOC and log resistivity is analyzed, as illustrated in the figure. Fitting is performed to obtain the following relational expression between them:

Y_{log resistivity}=−0.563*X_{TOC}+3.165.

According to the above analysis, the TOC of the corresponding rock stratum can be obtained after the resistivity of the core sample is tested at this frequency.

The test data of CaO (calcium oxide) and loss on ignition are summarized, as illustrated in (b) of FIG. 6. A correlation between CaO and loss on ignition is analyzed. Fitting is performed to obtain the following relational expression between them:

Y_{loss on ignition}=0.66*X_{CaO}+7.15.

According to the above analysis, it can be found that there is a negative correlation between the sample resistivity and TOC, and the sample CaO is closely correlated to the loss on ignition, which proves that the CaO content of the sample is mainly determined by the calcium carbonate rock, and carbonate is mainly characterized by high resistivity. Therefore, through PetroEM analysis, it can be seen that TOC and low resistivity are internally related, carbonate and high resistivity are internally related, and TOC and carbonate can be connected with oil/gas related marine environment. Therefore, PetroEM measurement can be used to indirectly predict paleomarine environment and predict the oil/gas development situation together with development environment.

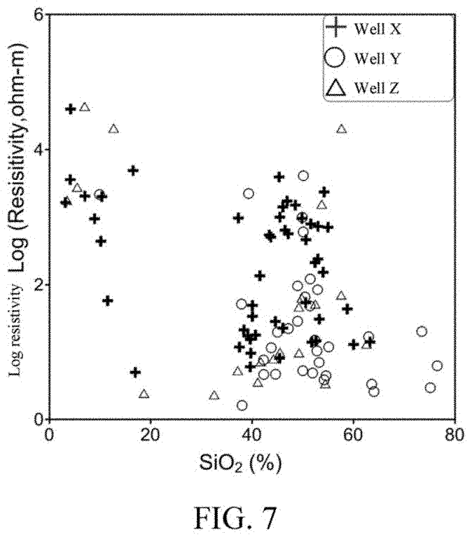

The test data of log resistivity and quartz content of the core samples measured at 0.01 Hz are summarized, as illustrated in FIG. 7. Well X represents summarization results of test data of quartz content and log resistivity measured in a corresponding borehole of a typical oil/gas reservoir (southwest edge of Upper Yangtze plate of South China), well Y represents summarization results of test data of quartz content and log resistivity measured in a first exploration area, and well Z represents summarization results of test data of quartz content and log resistivity measured in a second exploration area. Since these data do not show good correlation, scatter point analysis is performed to these data, and a relationship between quartz content and rock resistivity and impedance can be obtained through fitting (such as double log linear fitting) or trend analysis.

Through the above analysis, a correlation between electromagnetic characteristics and geochemical characteristics of the typical oil/gas reservoir at this frequency can be established.

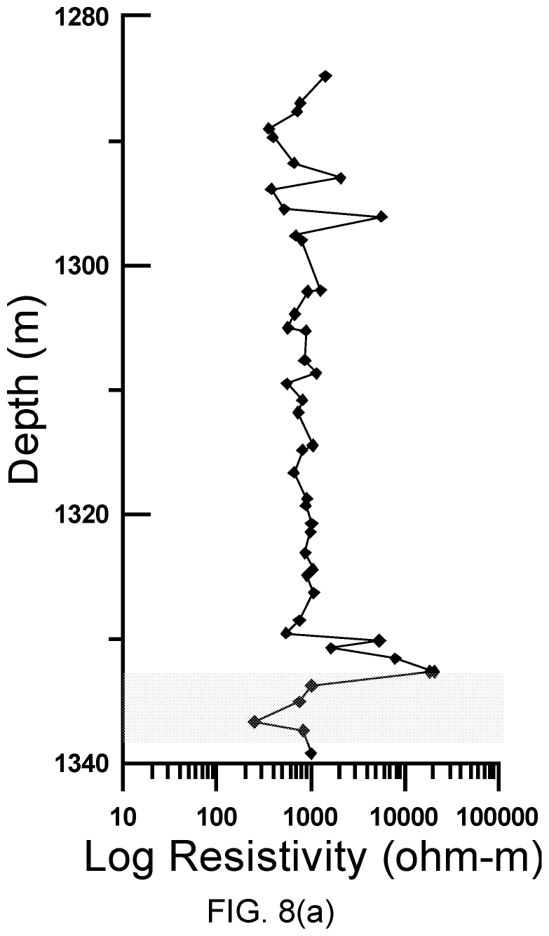

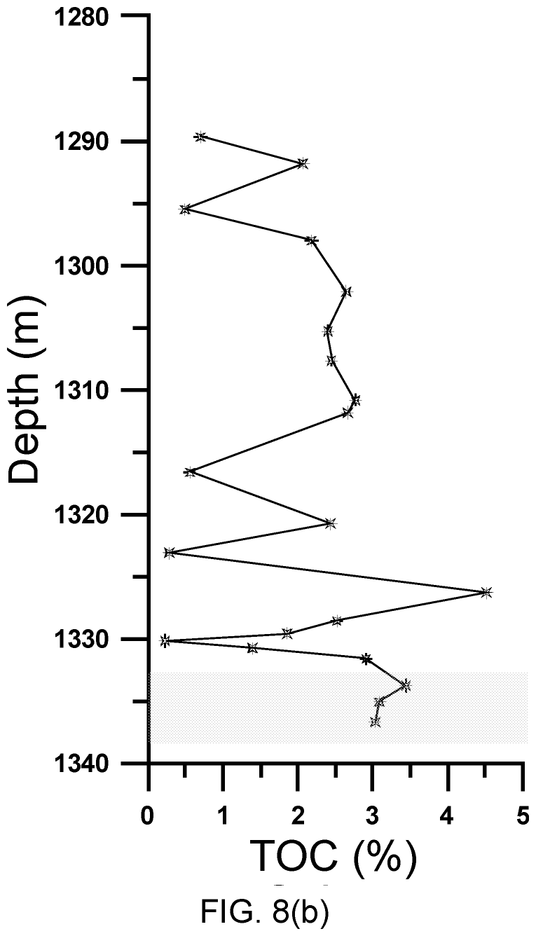

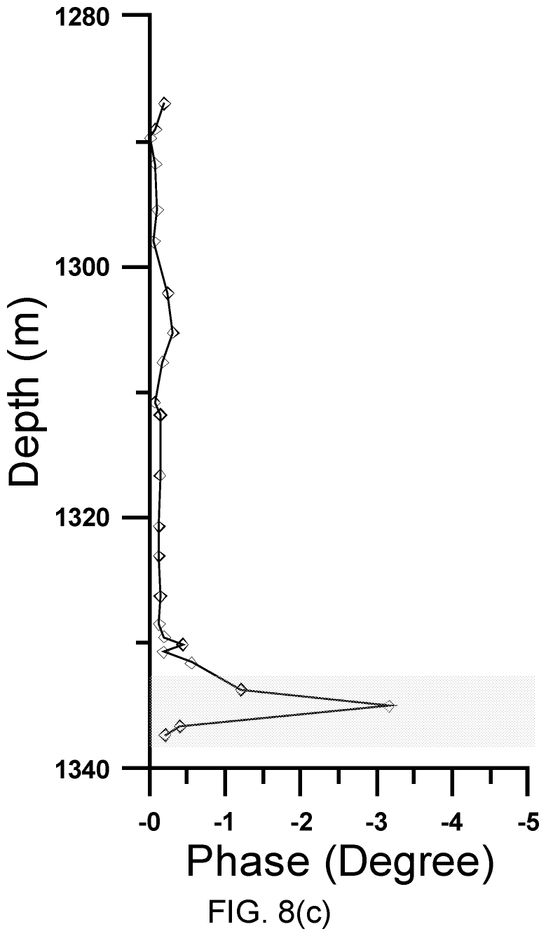

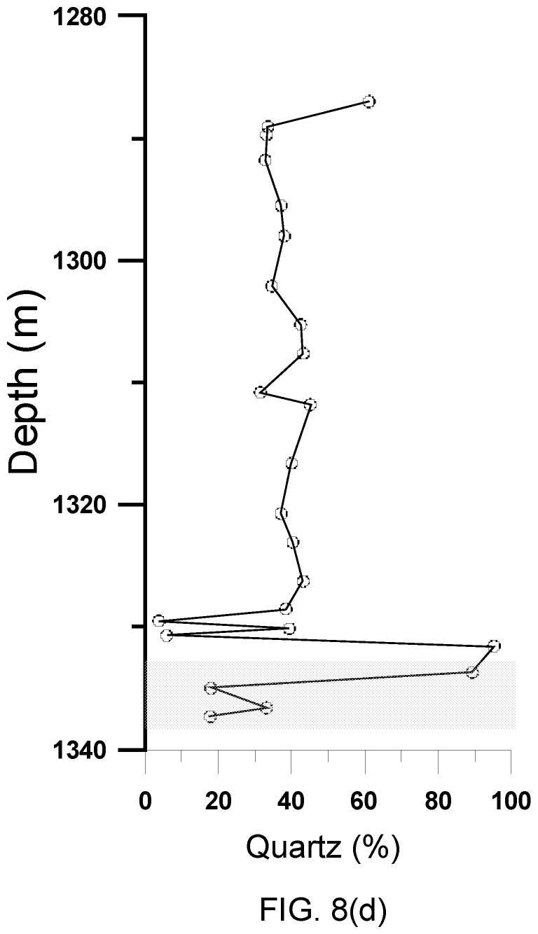

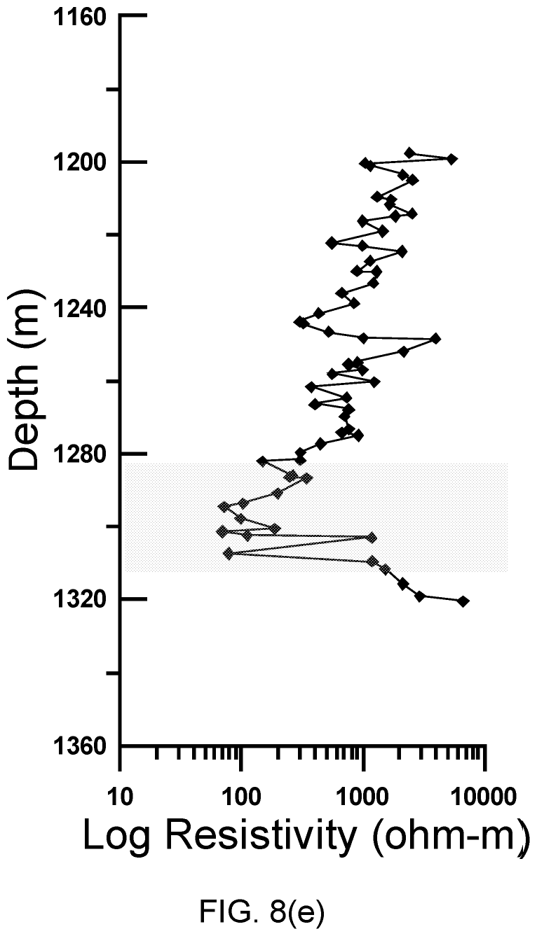

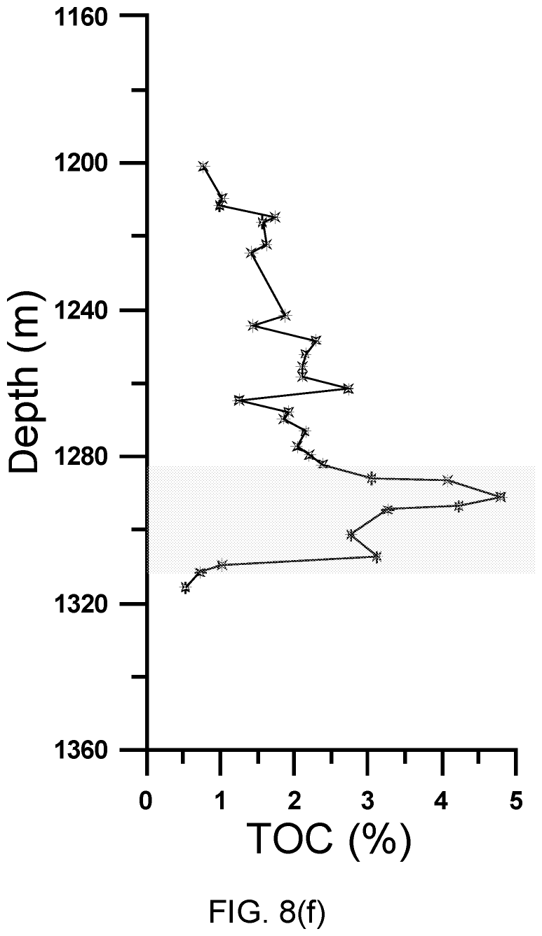

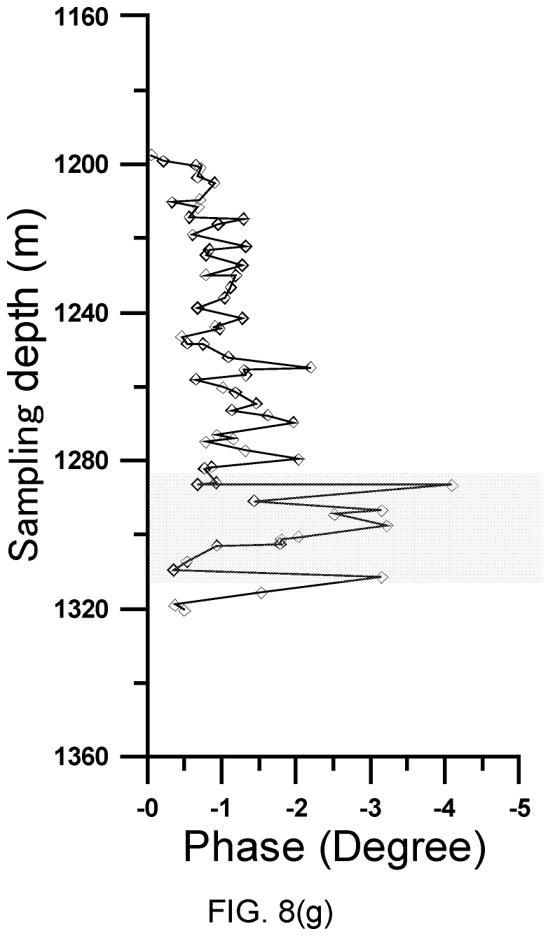

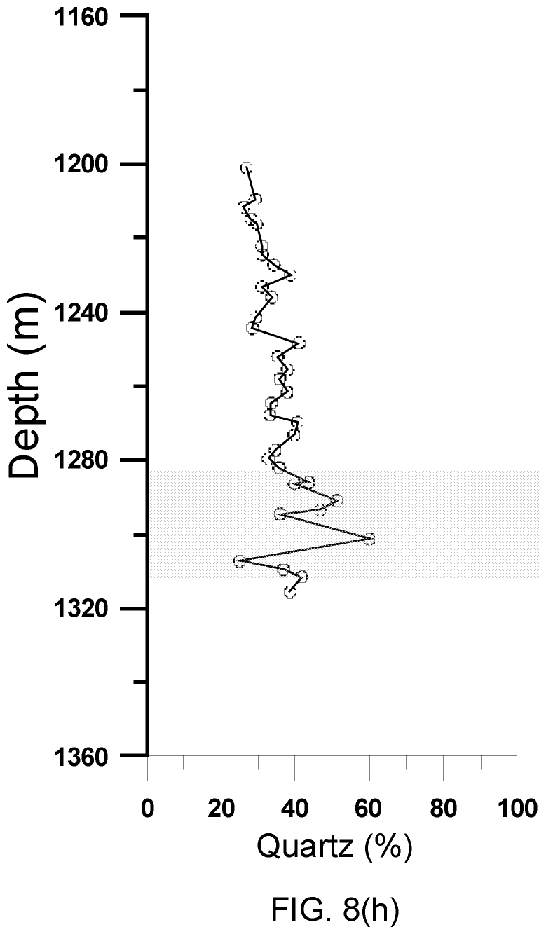

Further, the test data of log resistivity, phase, TOC and quartz content of the core sample are summarized, so that resistivity-phase-TOC and resistivity-phase-quartz content attribute models established after correlation analysis of known well X at frequency of 0.01 Hz illustrated in (a) to (d) of FIG. 8 can be obtained.

Similarly, a correlation between electromagnetic characteristics and geochemical characteristics of different characteristic types of deposits or reservoirs can be established, and a corresponding resistivity-phase-rock attribute model can be established.

For the first oil/gas exploration area (corresponding borehole is prediction well Y, a concealed resource prediction process includes the following steps:

B1) Complex impedance measurement: core samples at different depths are extracted from the exploration area. The PetroEM measurement system 1 provided in Example 1 is adopted to perform complex impedance measurement to the core samples under the condition of applying a frequency range of 0.001-1000 Hz.

B2) prediction factor extraction and model establishment: a real part and an imaginary part of the measured complex impedance are calculated through Fourier transform (the corresponding impedance amplitude and phase can be obtained through the real part and the imaginary part). On this basis, the resistivities of the core samples can be calculated by multiplying the impedance amplitude by the shape coefficient of the sample. The obtained resistivity and impedance phase are two electromagnetic prediction factors.

Conventional macro-analysis, Total Organic Carbon (TOC) analysis, fluorescence analysis and the like are adopted to obtain geochemical prediction factor related to oil/gas, such as TOC content, quartz content, CaO content and loss on ignition.

Then, by comparing the measured electromagnetic characteristics of the prediction well Y with the electromagnetic characteristics of different characteristic types of reservoirs, a similar resistivity-phase-rock attribute model can be obtained, from which the geochemical prediction factor that can characterize the first oil/gas reservoir exploration area can be seen. The landmark geochemical prediction factor in this application example are TOC and quartz content.

The test data of log resistivity, phase, TOC and quartz content of the core samples measured at 0.01 Hz are summarized, so that resistivity-phase-TOC and resistivity-phase-quartz content attribute models of the typical oil/gas reservoir at 0.01 Hz can be established, as illustrated in (e)-(h) of FIG. 8.

B3) Resource prediction:

By comparing the attributes of resistivity-phase-TOC and resistivity-phase-quartz content of a well section at depth of 1280-1310 m of the prediction well Y with the corresponding parts given in models (a) to (d) of FIG. 8, it can be seen that it shows the characteristics of low resistivity, high polarization, high TOC, high quartz and the like, so it can be predicted that the well section at depth of 1280-1310 m of the prediction well Y is a favorable area for shale gas.

Based on the resistivity-phase-TOC and resistivity-phase-quartz content attribute models established in FIG. 8, the porosity and gas bearing property of the organic-rich shale can be evaluated by using TOC and quartz content. For example, it can be seen from FIG. 8 that TOC increases obviously along the well section at depth of 1280-1310 m, which indicates that this section is conducive to shale gas development from the perspective of geochemical indicators; quartz content increases obviously along the well section at depth of 1280-1310 m, which indicates that the brittle minerals in this section increase and it is conducive to shale gas development; phase distribution along depth increases obviously along the well section at depth of 1280-1310 m, which also indicates that this section is conducive to shale gas development. Accordingly, it can be seen that the combined anomaly characteristics of TOC-resistivity-quartz content-impedance phase can be used to more accurately recognize and analyze the favorable area for shale gas development than TOC alone, and petroEM logging can assist in resource recognition.

For the third oil/gas exploration area (corresponding borehole is marked as prediction well XD, a concealed resource prediction process includes the following steps:

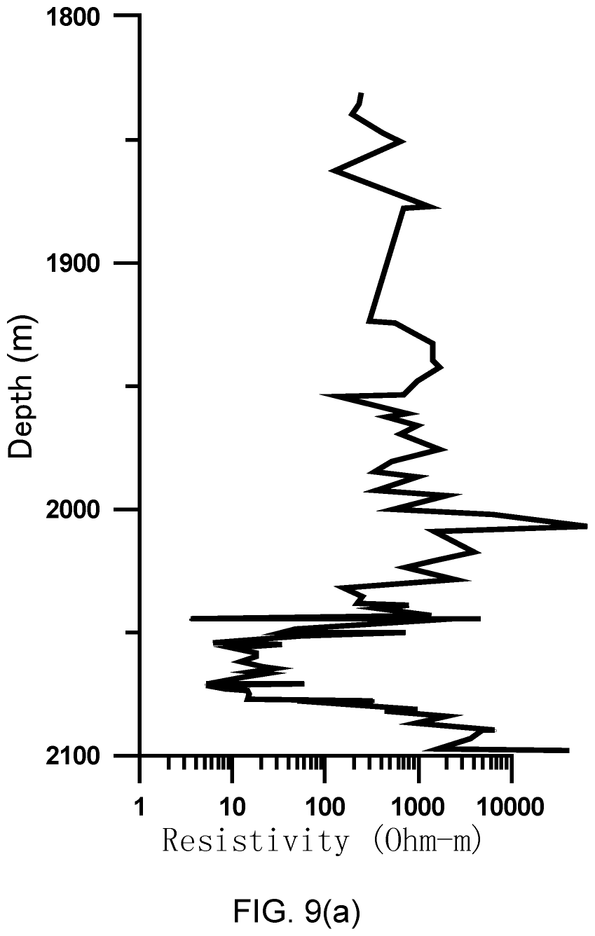

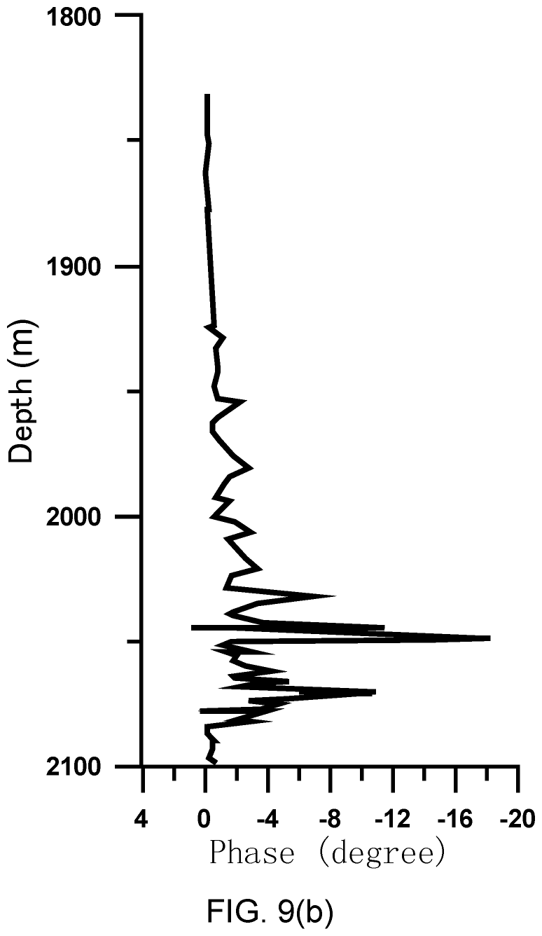

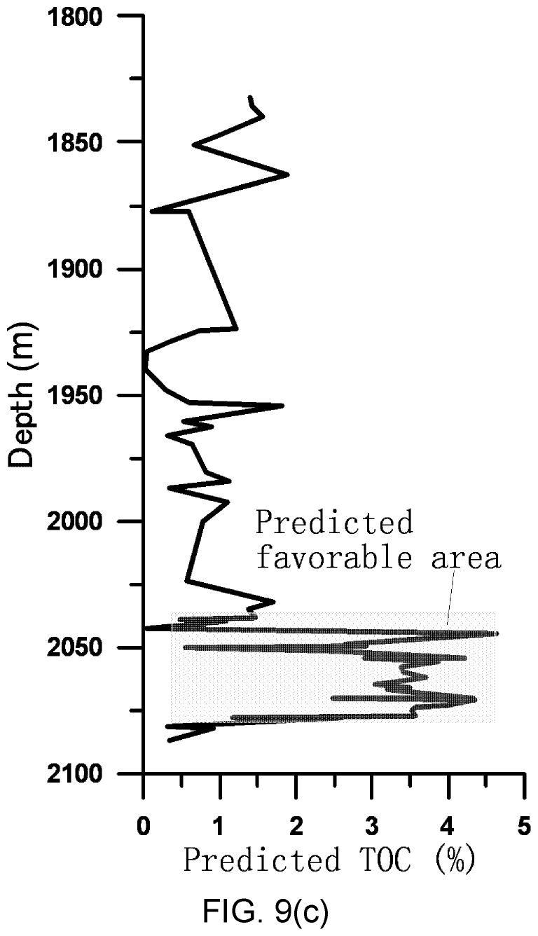

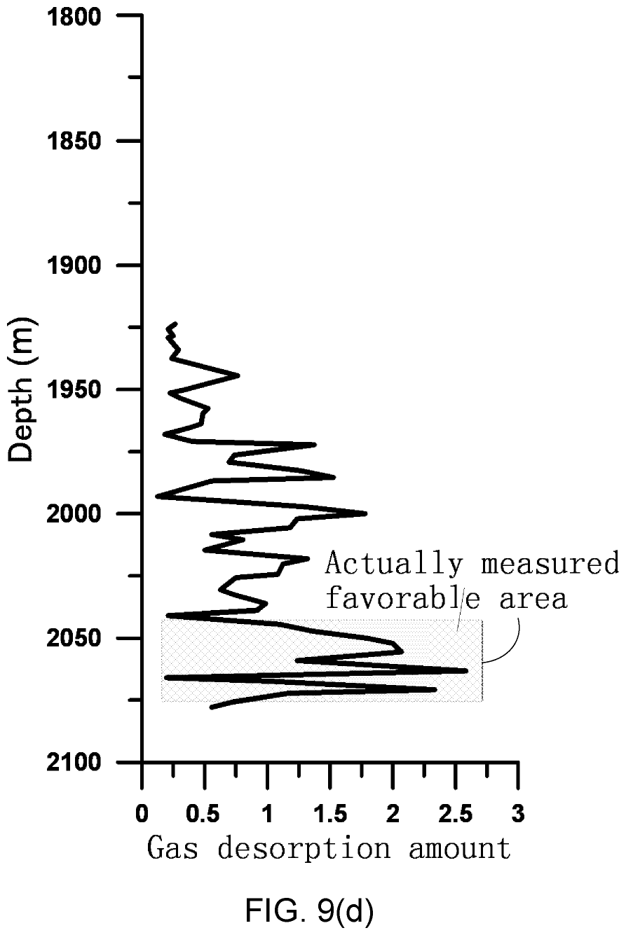

B1) Complex impedance measurement: core samples at different depths are extracted from the exploration area. The PetroEM measurement system 1 provided in Example 1 is adopted to perform complex impedance measurement to the core samples under the condition of applying a frequency range of 0.001-1000 Hz. B2) prediction factor extraction and model establishment: a real part and an imaginary part of the measured complex impedance are calculated through Fourier transform (the corresponding impedance amplitude and phase can be obtained through the real part and the imaginary part). On this basis, the resistivities of the samples can be calculated by multiplying the impedance amplitude by the shape coefficient of the sample. The obtained resistivity and impedance phase are two electromagnetic prediction factors. The measurement results are as illustrated in (a) and (b) of FIG. 9.

By using the resistivity-TOC model Y_{log resistivity}=−0.563*X_{TOC}+3.165, the geochemical prediction factor and distribution corresponding to the prediction well XD can be inferred, the landmark geochemical prediction factor TOC in this application example is obtained, and the inferred TOC can be used to predict the gas-bearing favorable area, as illustrated in (c) of FIG. 9.

The test (or prediction) data of log resistivity, phase and TOC of the core samples measured at 0.01 Hz are summarized, so that a resistivity-phase-TOC attribute model of the typical oil/gas reservoir at 0.01 Hz can be established.

B3) Resource prediction:

According to the resistivity-phase-TOC attribute model of the well section at depth of 2042-2083 m of the prediction well XD obtained by inferring according to the resistivity model, it can be seen that it shows the characteristics of low resistivity, high polarization, high TOC and the like. Therefore, it can be predicted that the well section at depth of 2042-2083 m of the prediction well XD is a favorable area for shale gas, which is basically consistent with the result of field gas content analysis in the well section at depth of 2045-2075 m ((d) in FIG. 9d)

What is claimed is:

1. A petro-electromagnetism (petroEM) logging system, wherein the petroEM logging system comprises a ground based transmitter and data acquisition unit (DAU), a sensors system placed in a borehole or tunnel; the sensors system comprises current (current supply) electrodes and voltage (receiver measurement) electrodes, the current electrodes are connected to the ground based transmitter through a transmitter cable, and the voltage electrodes are connected to the DAU through a receiver cable; the transmitter transmits electromagnetic waves into a logging borehole through the current electrodes, and the DAU measures a complex impedance at a position of an electrode device in the logging borehole through receiver electrodes; and the petroEM logging system predicts concealed resources according to the following steps:
A1) performing a complex impedance measurement to an ore body or oil/gas reservoir and a bed rock sample obtained from a borehole or tunnel in an exploration area within a set frequency range of 0.001-0.01 Hz;
or performing an in-well complex impedance measurement along the borehole or tunnel in the exploration area within the set frequency range of 0.001-0.01 Hz;
A2) according to the complex impedance measurement result, extracting resistivity and phase information of the ore body or oil/gas reservoir and the bed rock sample at different set frequencies in the exploration area, then obtaining impedance phase differences or resistivity ratios of the ore body or oil/gas reservoir and the bed rock sample at multiple set frequencies in a same frequency band, and using an average value of the impedance phase differences or resistivity ratios as an electromagnetic prediction factor; and
A3) predicting the concealed resources in the exploration area according to the electromagnetic prediction factor and a set standard;
or the petroEM logging system predicts the concealed resources according to the following steps:
B1) performing the complex impedance measurement to the ore body or oil/gas reservoir and the bed rock sample obtained from the borehole or tunnel in the exploration area within the set frequency range of 0.001-0.01 Hz;
or performing the in-well complex impedance measurement along the borehole or tunnel in the exploration area within the set frequency range of 0.001-0.01 Hz;
B2) according to a result of the complex impedance measurement, extracting resistivity and phase information at different set frequencies, and using the resistivities and phases as the electromagnetic prediction factor; then, according to a correlation between electromagnetic characteristics and geochemical characteristics obtained through rock geochemical analysis, obtaining a geochemical prediction factor at different set frequencies, and further, according to the electromagnetic prediction factor and the geochemical prediction factor at different set frequencies, establishing a resistivity-phase-rock attribute model, wherein
the correlation between the electromagnetic characteristics and the geochemical characteristics obtained through rock geochemical analysis is established by performing complex impedance analysis to several known metal ore deposits or oil/gas reservoirs, obtaining the electromagnetic prediction factor, obtaining the geochemical prediction factor related to resources by adopting macro-analysis, micro-analysis, and loss-on-ignition analysis, and then establishing a correlation between the electromagnetic prediction factor and the geochemical prediction factor through correlation coefficient analysis and scatter point analysis; and
B3) predicting the concealed resources in the exploration area using the resistivity-phase-rock attribute model.

2. The petroEM logging system according to claim 1, wherein the exploration area is an area where ore-bearing, water-bearing or oil/gas resources need to be predicted.

3. A petro-electromagnetism (petroEM) logging system, wherein the petroEM logging system comprises a transmitting device on the ground and a receiver device and an electrode device in a borehole or tunnel; the electrode device comprises transmitting electrodes and receiver electrodes, the transmitting electrodes are connected with a transmitting end of the transmitting device through transmission lines, and the receiver electrodes are connected with a receiver end of the receiver device through transmission lines; the transmitting device transmits electromagnetic waves into a logging well through the transmitting electrodes, and the receiver device measures a complex impedance at a position of the electrode device in the logging well through the receiver electrodes;
the petroEM logging system predicts concealed resources according to the following steps:
A1) performing a complex impedance measurement to an ore body or oil/gas reservoir and a bed rock sample obtained from a borehole or tunnel in an exploration area within a set frequency range of 0.001-0.01 Hz;
or performing an in-well complex impedance measurement along the borehole or tunnel in the exploration area within the set frequency range of 0.001-0.01 Hz;
A2) according to the complex impedance measurement result, extracting resistivity and phase information of the ore body or oil/gas reservoir and the bed rock sample at different set frequencies in the exploration area, then obtaining impedance phase differences or resistivity ratios of the ore body or oil/gas reservoir and the bed rock sample at multiple set frequencies in the same frequency band, and using an average value of the impedance phase differences or resistivity ratios as an electromagnetic prediction factor; and
A3) predicting the concealed resources in the exploration area according to the electromagnetic prediction factor and a set standard;
or the petroEM logging system predicts the concealed resources according to the following steps:
B1) performing the complex impedance measurement to the ore body or oil/gas reservoir and the bed rock sample obtained from the borehole or tunnel in the exploration area within the set frequency range of 0.001-0.01 Hz;
or performing the in-well complex impedance measurement along the borehole or tunnel in the exploration area within the set frequency range of 0.001-0.01 Hz;
B2) prediction factor extraction and model establishment: according to a result of the complex impedance measurement, extracting resistivity and phase information at different set frequencies, and using the resistivities and phases as the electromagnetic prediction factor; then, according to a correlation between electromagnetic characteristics and geochemical characteristics obtained through rock geochemical analysis, obtaining a geochemical prediction factor at different set frequencies, and further, according to the electromagnetic prediction factor and the geochemical prediction factor at different set frequencies, establishing a resistivity-phase-rock attribute model, wherein
the correlation between the electromagnetic characteristics and the geochemical characteristics obtained through rock geochemical analysis is established by performing complex impedance analysis to several known metal ore deposits or oil/gas reservoirs, obtaining the electromagnetic prediction factor, obtaining the geochemical prediction factor related to resources by adopting macro-analysis, micro-analysis, and loss-on-ignition analysis, and then establishing a correlation between the electromagnetic prediction factor and the geochemical prediction factor through correlation coefficient analysis and scatter point analysis; and
B3) resource prediction: predicting the concealed resources in the exploration area using the established resistivity-phase-rock attribute model.

4. The petroEM logging system according to claim 3, wherein the exploration area is an area where ore-bearing, water-bearing or oil/gas resources need to be predicted.
